(19) United States
(12) Patent Application Publication
(10) Pub. No.: US 2002/0103009 A1
(43) Pub. Date: Aug. 1, 2002

(54) Mobile communication apparatus and method

(75) Inventor: Hiroaki Sato, Tokyo (JP)

Correspondence Address: BANNER & WITCOFF, 1001 G STREET N W, SUITE 1100, WASHINGTON, DC, 20001, US

(73) Assignee: Kabushiki Kaisha Tashiba, Tokyo (JP)

(21) Appl. No.: 10/038,864

(22) Filed: Jan. 8, 2002

(30) Foreign Application Priority Data
Jan. 12, 2001 (JP) P2001-005553

(51) Int. Cl. H04M 1/00

(52) U.S. Cl. 455/558; 455/557

(57) ABSTRACT

A mobile communication apparatus is able to receive plural IC (e.g., USIM) cards and suitably control an operation of the apparatus using a selected one of the received IC cards. The mobile communication apparatus has plural sockets able to mount the plural USIM cards; the mounting of USIM cards in the sockets is detected. Activation of the USIM cards can be performed based upon this detection. After activation, position register information can be read from the activated USIM card(s) and location registry of the mobile communication apparatus with the network can be performed. Selection of an activated USIM card for establishing a communication link with the network may be carried out based upon various factors, including the time of use, a home location of the apparatus and information broadcast by a mobile network. As one advantage of the invention, it is possible to decrease call charges when the mobile communication apparatus is in a roaming country, if the mobile communication apparatus has a USIM card indicating a country code of the roaming country.

### RELATED APPLICATION INFORMATION

This disclosure is related to and claims priority to Japanese Patent application P2001-5553 filed on Jan. 12, 2001, the entire content of which is incorporated herein by reference.

### FIELD OF THE INVENTION

This invention relates to a communication apparatus permitting insertion of an integrated circuit (IC) card for communicating, and particularly relates to a control method carried out by a communication apparatus into which a plurality of IC cards may be inserted.

### BACKGROUND OF THE INVENTION

A Subscriber Identification Module (SIM) card is necessary for the Global System for Mobile communication (GSM), which is standardized in Europe. The SIM card can comprise a plurality of integrated circuits (IC). The SIM card is used for communicating with a mobile communication network. The SIM card includes information such as an authentication algorithm required for communication, an identification number, etc. The identification number is used for identifying a subscriber as a rightful user in the mobile network. A mobile phone in GSM can communicate with the network upon inserting the SIM card into the phone.

Now, a third generation mobile phone system, which is called International Mobile Telecommunications 2000 (IMT2000), is being standardized all over the world. In the IMT2000, a Universal Subscriber Identity Module (USIM) card is necessary for communicating with a mobile communication network. The USIM card has basically the same function as the SIM card in the GSM.

The USIM card includes data such as an authentication algorithm required for communication and an identification number for identifying a subscriber as a rightful user in the mobile communication system, same as the SIM card.

The USIM card has a data storage section. The identification number is included in the storage section “Elementary File_International Mobile Subscriber Identity (EF_IMSI) in an Elementary File (EF)” as data. The mobile phone informs the mobile communication network of the identification number, for identifying the subscriber. The EF_IMSI also includes a code indicating a home country of the network to which the mobile phone belongs.

For example, a subscriber A has a USIM card whose home country code is Japanese country code “81”, and whose whole telephone number is “09001234567”, and a subscriber B has a USIM card whose home country is Japanese country code “81”. When they are located in a roaming country and subscriber B calls subscriber A, subscriber B has to input the telephone number “81+09001234567”. In this case, at first, subscriber A's phone accesses a home network in its home country. After accessing the home network, the subscriber's phone accesses a roaming network in a roaming country. Accordingly, although subscriber A and subscriber B are located in the same roaming country and they have the same home country code, subscriber A has to pay an international call charge. Thus, a call charge is not determined by only the location of a calling subscriber and a called subscriber, but also depends on the home country code of the USIM card of the calling subscriber and that of the called subscriber. To avoid such charges, it is advantageous for a user to switch-out plural USIM cards having different home country codes.

### SUMMARY OF THE INVENTION

In consideration of the above situation, an object of the present invention is to provide a mobile communication apparatus capable of setting a plurality of IC cards to communicate with a network, wherein each of the IC cards has data to communicate with the network.

In a first aspect, the present invention provides a mobile communication apparatus for communicating with a network selectively utilizing a plurality of IC units connected to the apparatus, each of the IC units having data for establishing a communication link with the network. A detector is configured to detect each of the IC units connected to the apparatus. An activator is configured to activate at least one of the detected IC units for communication with the network. A controller is configured to inform the network of data in the activated IC unit(s).

This invention also provides a method for selectively utilizing a plurality of IC units connected to a mobile communication apparatus for communicating with a network, each of the IC units having data for establishing a communication link with the network. In the method, each of the IC units connected to the apparatus is detected. At least one of the detected IC units is activated for communication with the network, and the network is informed of data in the activated IC unit(s).

In a third aspect, the invention provides a mobile communication apparatus for receiving a plurality of IC units to communicate with a network, each of the IC units having data for establishing a communication link with the network. Pluralities of sockets are configured to receive the plurality of IC units. A detector is configured to detect an IC unit received in a socket. An activator is configured to activate the detected IC unit for communication with the network. A controller is configured to inform the network of data in the activated IC unit.

In a fourth aspect, the invention provides a method carried out in a mobile communication apparatus for communicating with a network, the apparatus having a plurality of sockets for receiving a plurality of IC units, and each of the IC units having data for establishing a communication link with the network. An IC unit received in a socket is detected. The detected IC unit is activated for communication with the network, and the network is informed of data in the activated IC unit.

The above and other objects, features and advantages of the present invention will be readily apparent and fully understood from the following detailed description of preferred embodiments, taken in connection with the appended drawings.

### BRIEF DESCRIPTION OF THE DRAWINGS

FIG. 1 is a block diagram showing functional elements of a mobile communication apparatus able to detachably mount a USIM card in one embodiment of the invention.

FIG. 2 is a block diagram showing in more detail functional elements of the mobile communication apparatus illustrated in FIG. 2.

FIG. 3 is a graphical representation of a process that may be carried out by the communication apparatus shown in FIGS. 1 and 2, when a USIM card is inserted into each of plural sockets of the communication apparatus.

FIG. 4 is a graphical representation of another process that may be carried out by the communication apparatus shown in FIGS. 1 and 2, when a USIM card is inserted into each of the plural sockets of the communication apparatus.

FIG. 5 is a graphical representation of another process that may be carried out by the communication apparatus shown in FIGS. 1 and 2, when USIM cards are respectively inserted into the plural sockets of the communication apparatus.

FIG. 6 is a graphical representation of a process carried out by the communication apparatus shown in FIGS. 1 and 2, when a USIM card is inserted into one of the plural sockets of the communication apparatus and another USIM card is then further mounted in another one of the sockets.

FIG. 7 is a graphical representation of a process carried out by the mobile communication apparatus shown in FIGS. 1 and 2, when USIM cards are respectively inserted into the plural sockets of the communication apparatus and one of the USIM cards is then pulled out of its socket.

FIG. 8 is a graphical representation of a process carried out by the mobile communication apparatus shown in FIGS. 1 and 2 after USIM cards are respectively inserted into the plural sockets of the communication apparatus and location registration is completed (incoming call).

FIG. 9 is a graphical representation of a process carried out by the communication apparatus shown in FIGS. 1 and 2 after USIM cards are respectively inserted into the plural sockets of the mobile communication apparatus and location registration is completed (outgoing call).

FIG. 10 is a graphical representation of a process for activating one of the USIM cards carried out by the mobile communication apparatus shown in FIGS. 1 and 2, after the USIM cards are respectively inserted into the plural sockets of the mobile communication apparatus.

FIG. 11 is a graphical representation of a process for deactivating one of the USIM cards carried out by the mobile communication apparatus shown in FIGS. 1 and 2, after the USIM cards are respectively inserted into the plural sockets of the mobile communication apparatus and are respectively activated.

FIG. 12 is a graphical representation of a process for selectively allowing communication with respect to USIM cards carried out by the mobile communication apparatus shown in FIGS. 1 and 2, after the USIM cards are respectively inserted into the plural sockets of this mobile communication apparatus and location registration is completed (outgoing call).

FIG. 13 is a graphical representation of a process for selectively allowing signal arrival with respect to USIM cards carried out by the mobile communication apparatus shown in FIGS. 1 and 2, after the USIM cards are respectively inserted into the plural sockets of this mobile communication apparatus and location registration is completed (incoming call).

FIG. 14 is a graphical representation of a process of signal transmission and arrival performed by automatically selecting for communication one of plural USIM cards mounted in the mobile communication apparatus shown in FIGS. 1 and 2.

### DETAILED DESCRIPTION OF THE PREFERRED EMBODIMENTS

A control method carried out in a communication apparatus using an IC card in one embodiment of the invention will be explained with reference to the drawings. In this embodiment, the communication apparatus is a radio communication apparatus and the Universal Subscriber Identity Module (USIM) card is an IC card. As used herein, “IC card” includes, but is not limited to thin card-like structures. The term encompasses integrated circuit modules or units of various types and provided with various physical configurations that permit attachment/detachment of the same to/from a host apparatus.

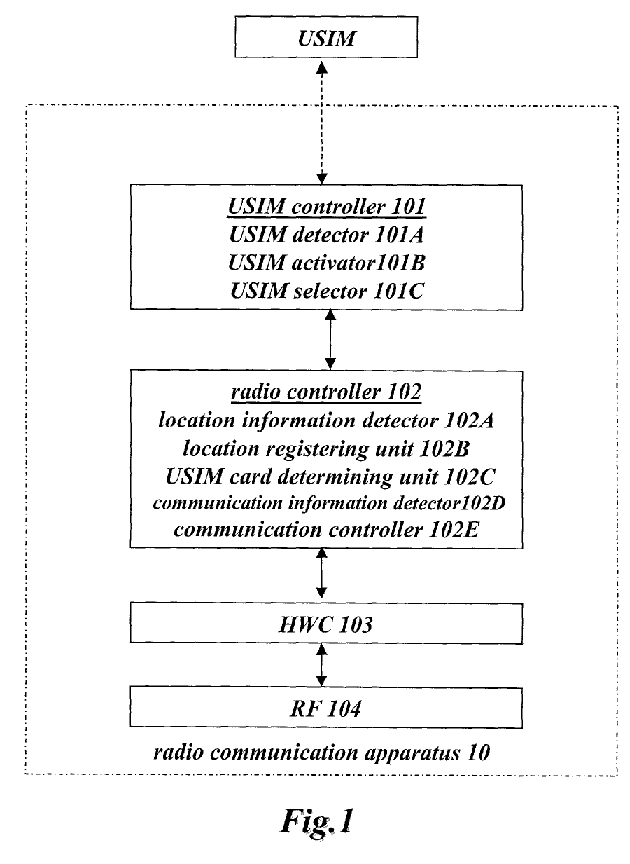

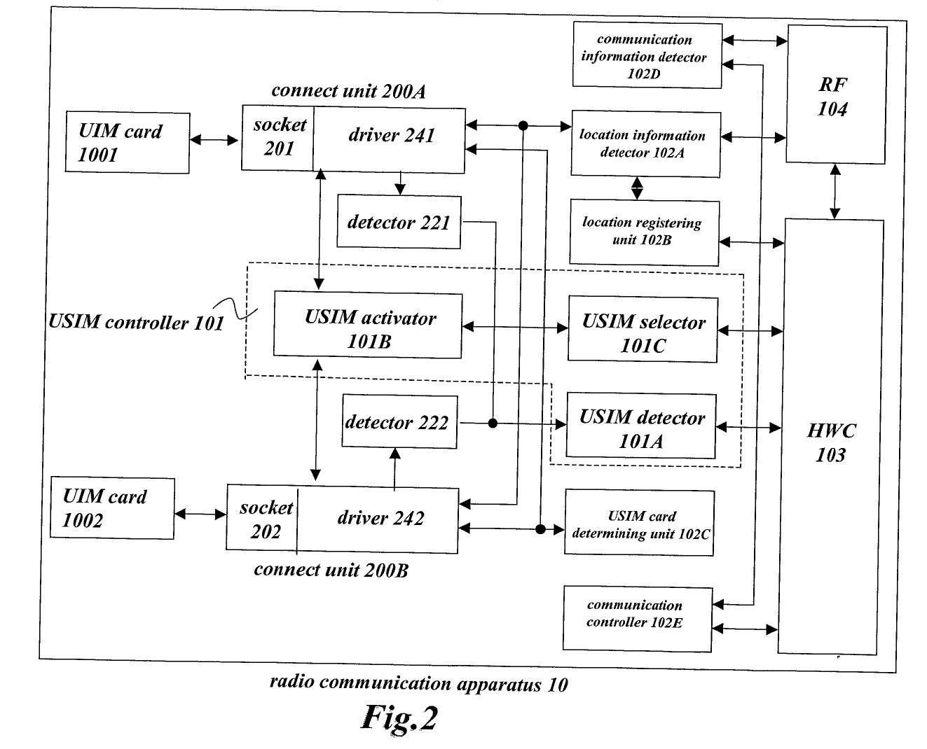

Referring to FIGS. 1 and 2, illustrated is a radio communication apparatus 10 to which a USIM card 1001 and 1002 may be detachably mounted. Each of USIM cards 1001 and 1002 stores various kinds of information, including identification information for identifying the subscriber in a mobile communication network, and a Mobile Country Code (MCC). USIM card 1001 and 1002 each have a data storage section. The storage section includes an Elementary File (EF). The EF includes a field “EF_IMSI”. The EF_IMSI includes the MCC. The MCC identifies the country of a mobile network with which a subscriber contracts.

Radio communication apparatus 10 has connecting units 200A and 200B as shown in FIG. 2. Connecting unit 200A has a socket 201 and a driver 241. Connecting unit 200B has a socket 202 and a driver 242. Socket 201 is used for connecting a USIM card. Driver 241 drives the connected USIM card. Socket 202 is used for connecting a USIM card. Driver 242 drives the connected USIM card.

Connecting units 200A and 200B are connected to a USIM controller 101 for controlling the USIM card, as shown in FIG. 1. The USIM controller includes a USIM detector a USIM activator 101B and a USIM selector 101C, as shown in FIG. 1.

As shown in FIG. 2, USIM detector 101A detects an attachment or detachment of USIM card 1001 in response to a signal from a detector 221 for detecting a mounting of the USIM card 1001 in socket 201. USIM detector 101A also detects an attachment or detachment of USIM card 1002 in response to a signal from a detector 222 for detecting a mounting of USIM card 1002 in the socket 202.

USIM activator 101B activates USIM card 1001 or USIM card 1002 for communicating with a mobile communication network. When USIM activator 101B activates USIM card 1001, it deactivates USIM card 1002. When USIM activator 101B activates the USIM card 1002, it deactivates USIM card 1001. USIM activator 101B has a function of initializing the activated USIM card 1001, 1002. A USIM selector 101C selects one or more USIM cards for activating (as will be described).

Radio communication apparatus 10 has a radio controller 102, as shown in FIG. 1. Radio controller 102 has a location information detector 102A, a location registering unit 102B, a USIM card determining unit 102C, a communication information detector 102D and a communication controller 102E. Location detector 102A detects location information relative to an existing location of communication apparatus 10. For example, location information detecting unit 102A obtains a MCC. The MCC includes information identifying a home country. A location registering unit 102B registers the detected information in a storing unit. USIM card determining unit 102C determines a USIM card for communicating (as will be described). Communication information detector 102D detects information from the determined USIM card for communicating with a mobile communication network. Communication controller 102E controls communication with a mobile communication network.

Communication apparatus 10 has a hardware control unit (HWC) 103 for controlling hardware in communication apparatus 10, and an RF section 104 for communicating with a mobile communication network. RF section 104 receives data over a radio channel from the mobile communication network. HWC 103 reads the received data and inputs the read data to other parts of the radio communication apparatus. For example, RF section 104 receives location information and communication information for establishing a communication link. The received location information is inputted to location information detecting unit 102A. The received communication information is inputted to communication information detector 102D.

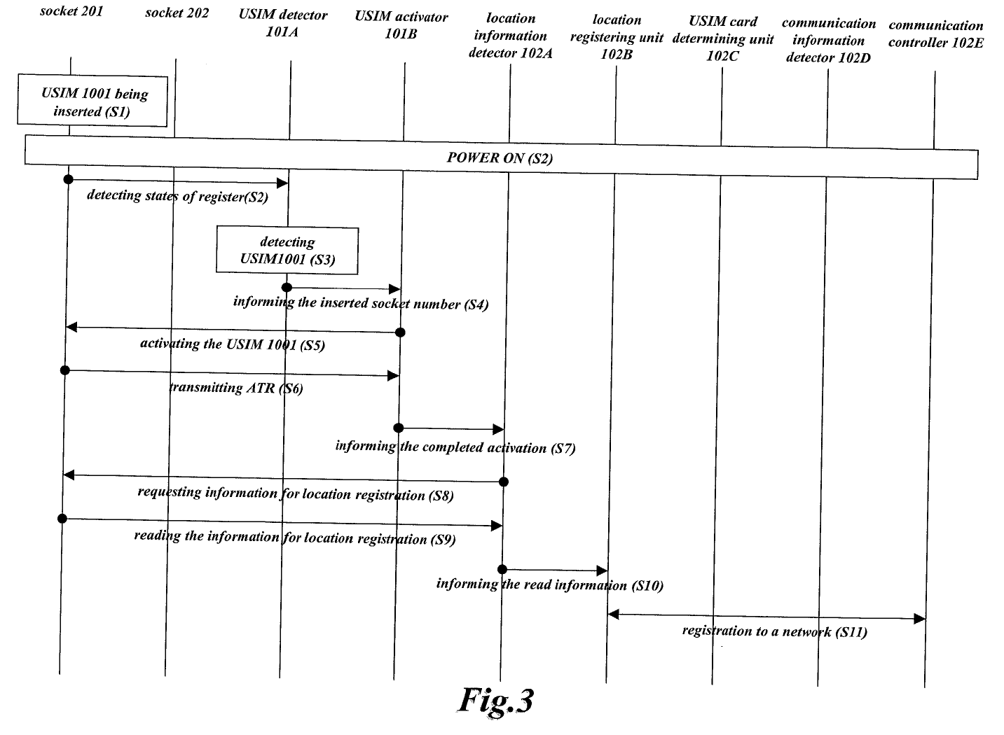

FIG. 3 is one example of a sequence executed by each functional block shown in FIGS. 1 and 2. An operation of one embodiment of this invention will be explained with reference to FIG. 3. FIG. 3 shows a sequence carried out when USIM 1001 is inserted in socket 201.

When a power source in the communication apparatus is turned on by a user or automatically after the USIM card 1001 is inserted to the socket 201 (S1), the detector 221 detects states of a register in driver 241 (S2). USIM detector 101A detects that USIM 1001 is inserted in socket 201 with reference to the detected states (S3). USIM detector 101A informs USIM activator 101B of the socket number into which the card is inserted (S4). USIM activator 101B activates USIM 1001 inserted in socket 201 (S5). In this action, power and clock signals are supplied to USIM 1001 for communicating with a mobile network using USIM 1001.

After being activated, USIM 1001 transmits “Answer to Reset” data (ATR) to USIM activator 101B (S6). USIM activator 101B can recognize that activation of USIM card 1001 has been completed upon receiving the ATR. USIM activator 101B informs location information detector 102A that activation of USIM card 1001 has been completed (S7).

After being notified that the activation of USIM card 1001 has been completed, location information detector 102A requests, for reading, information from USIM card 1001 for location registration of the card to the mobile network 1001(S8) and reads the necessary information from USIM 1001 (S9). Location information detector 102A informs location registering unit 102B of the read information (S10). Location registering unit 102B informs the mobile network of the read information for communicating with it. Thus, radio communication apparatus 10 communicates with the mobile network using USIM card 1001 (S11).

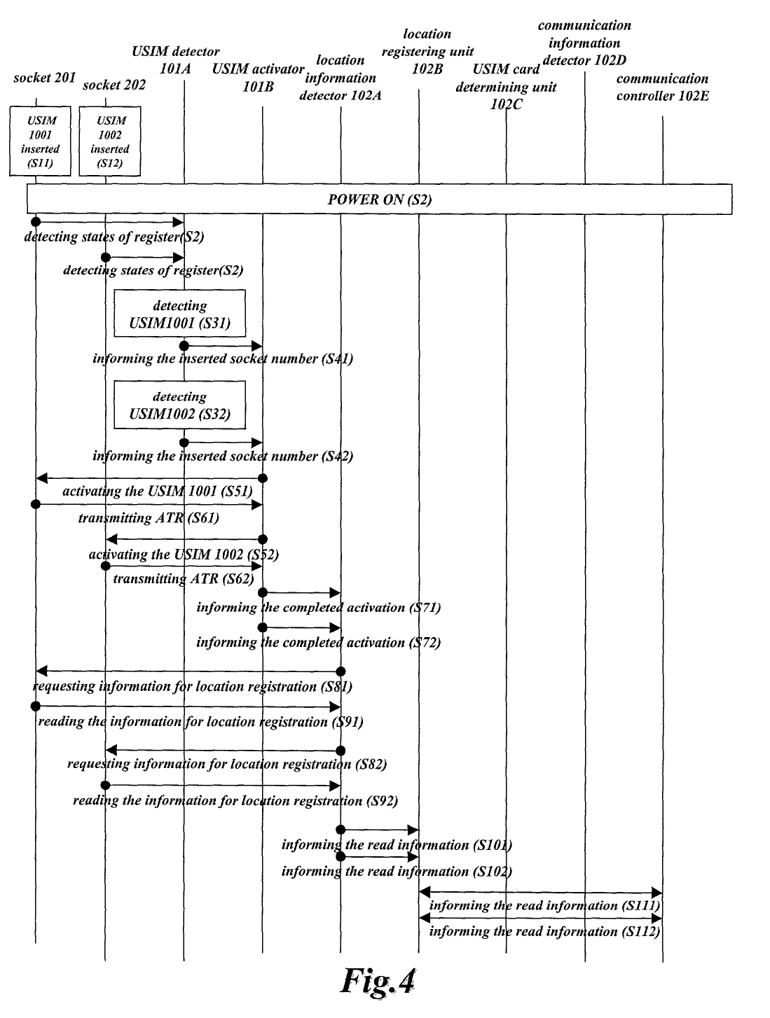

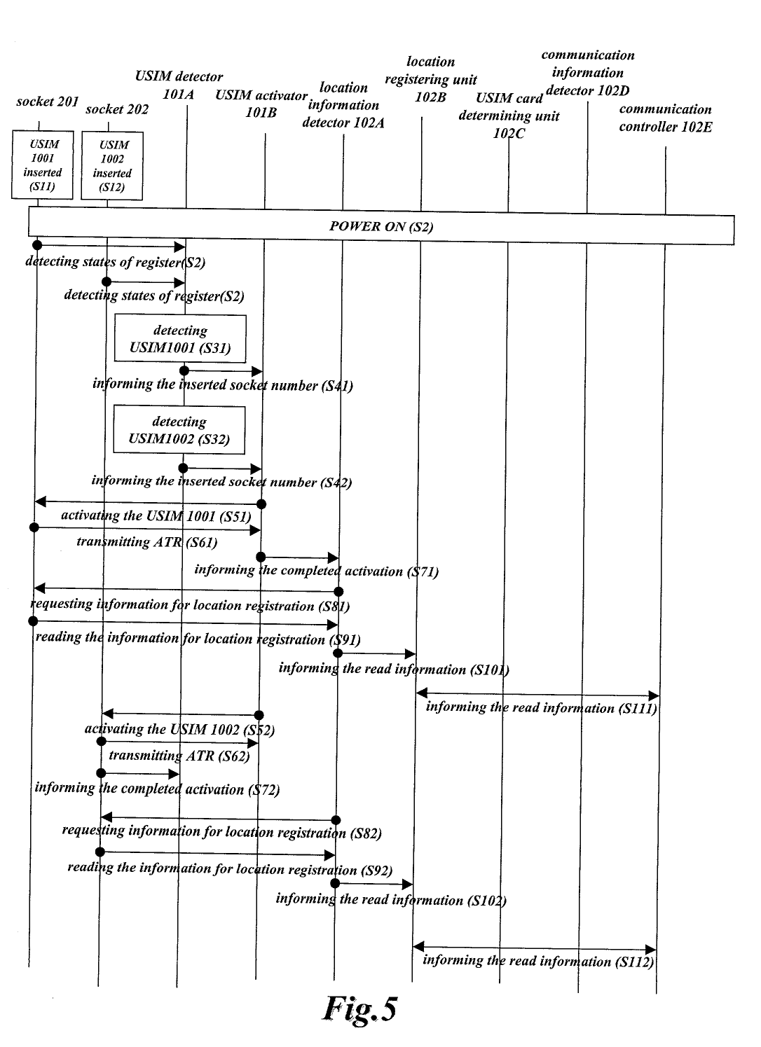

Each of FIGS. 4 and 5 shows a location registering process when plural USIM cards are inserted into radio communication apparatus 10. FIG. 4 shows the process in which a location registration is executed by repeating steps with respect to USIM cards 1001 and 1002.

When a power source in the communication apparatus is turned on by a user or automatically after USIM card 1001 is inserted into socket 201 (S11) and USIM card 1002 is inserted to the socket 202 (S12), detector 221 detects the states of the registers in drivers 241 and 242 (S2). USIM detector 101A detects that USIM 1001 is inserted in socket 201 with reference to the detected states (S31). The USIM detector informs USIM activator 101B of the occupied socket number (S41). Likewise, USIM detector 101A detects that USIM 1001 is inserted in socket 202 with reference to the detected states (S32), and informs USIM activator 101B of the occupied socket number (S42).

USIM activator 101B activates USIM 1001 inserted in socket 201 (S51). In this action, power and clock signals are supplied to USIM 1001, for communicating with a mobile network using USIM 1001. After being activated, USIM 1001 transmits ATR to USIM activator 101B (S61). USIM activator 101B can recognize that the activation of USIM card 1001 has been completed upon receiving the ATR.

USIM activator 101B activates USIM 1002 inserted in socket 202 (S52). In this action, power and clock signals are supplied to USIM 1002, for communicating with a mobile network using USIM 1002. After being activated, USIM 1002 transmits ATR to USIM activator 101B (S62). USIM activator 101B can recognize that the activation of USIM card 1002 has been completed upon receiving the ATR.

USIM activator 101B informs location information detector 102A that the activation of USIM card 1001 has been completed (S71). USIM activator 101B informs location information detector 102A that the activation of USIM card 1002 has been completed (S72).

After receiving notification that the activation of USIM card 1001 has been completed, location information detector 102A requests, for reading, information for location registration of card 1001 to a mobile network, and reads the necessary information from the USIM 1001 (S91). After receiving notification that the activation of USIM card 1002 has been completed, location information detector 102A requests, for reading, information for location registration of card 1002 to a mobile network, and reads the necessary information from USIM 1002 (S92).

Location information detector 102A informs location registering unit 102B of the information read from USIM 1001 (S101). Location information detector 102A informs location registering unit 102B of the information read from USIM 1002 (S102). Location registering unit 102B informs the mobile network of the read information for communicating using USIM card 1001 (S11). Location registering unit 102B informs the mobile network of the read information for communicating using USIM card 1002 (S112).

FIG. 5 shows an alternative process in which USIM card 1001 is processed from the activation to the location registration, after detection of the insertion of each of USIM cards 1001 and 1002, and USIM card 1002 is then processed from the activation to the location registration processing.

When a power source in the communication apparatus is turned on by a user or automatically after USIM card 1001 is inserted into the socket 201 (S11), and the USIM card 1002 is inserted into socket 202 (S12), detector 221 detects states of the registers in drivers 241 and 242 (S2). USIM detector 101A detects that the USIM 1001 is inserted in socket 201 with reference to the detected states (S31). USIM detector 101A informs USIM activator 101B of the occupied socket number (S41). USIM detector 101A detects that USIM 1001 is inserted into socket 202 with reference to the detected states (S32). USIM detector 101A informs USIM activator 101B of the inserted socket number (S42). USIM activator 101B activates USIM 1001 inserted in socket 201 (S51). In this action, power and clock signals are supplied to USIM 1001 for communicating with a mobile network using the USIM 1001.

After being activated, USIM 1001 ATR to USIM activator 101B (S61). USIM activator 101B can recognize that the activation of USIM card 1001 has been completed upon receiving the ATR. USIM activator 100B informs location information detector 102A that the activation of USIM card 1001 has been completed (S71). After receiving notification that the activation of USIM card 1001 has been completed, location information detector 102A requests, for reading, information for location registration of card 1001 to a mobile network (S11), and reads the necessary information from USIM 1001 (S91). Location information detector 102A informs location registering unit 102B of the information read from USIM 1001 (S101). Location registering unit 102B informs the mobile network of the read information, for communicating using USIM card 1001 (S111). USIM activator 101B activates USIM 1002 inserted in socket 202 (S52). In this action, power and clock signals are supplied to USIM 1002 for communicating with a mobile network using USIM 1002.

After being activated, USIM 1002 transmits ATR to USIM activator 101B (S62). USIM activator 100B can recognize that the activation of USIM card 1002 has been completed by receiving the ATR. USIM activator 101B informs location information detector 102A that activation of USIM card 1002 has been completed (S72). After receiving notification that the activation of USIM card 1002 has been completed, location information detector 102A requests, for reading, information for location registration of card 1002 to a mobile network (S82), and reads the necessary information from USIM 1002 (S92). Location information detector 102A informs location registering unit 102B of the information read from USIM 1002 (S102). Location registering unit 102B informs of mobile network of the read information, for communicating using USIM card 1002 (S112).

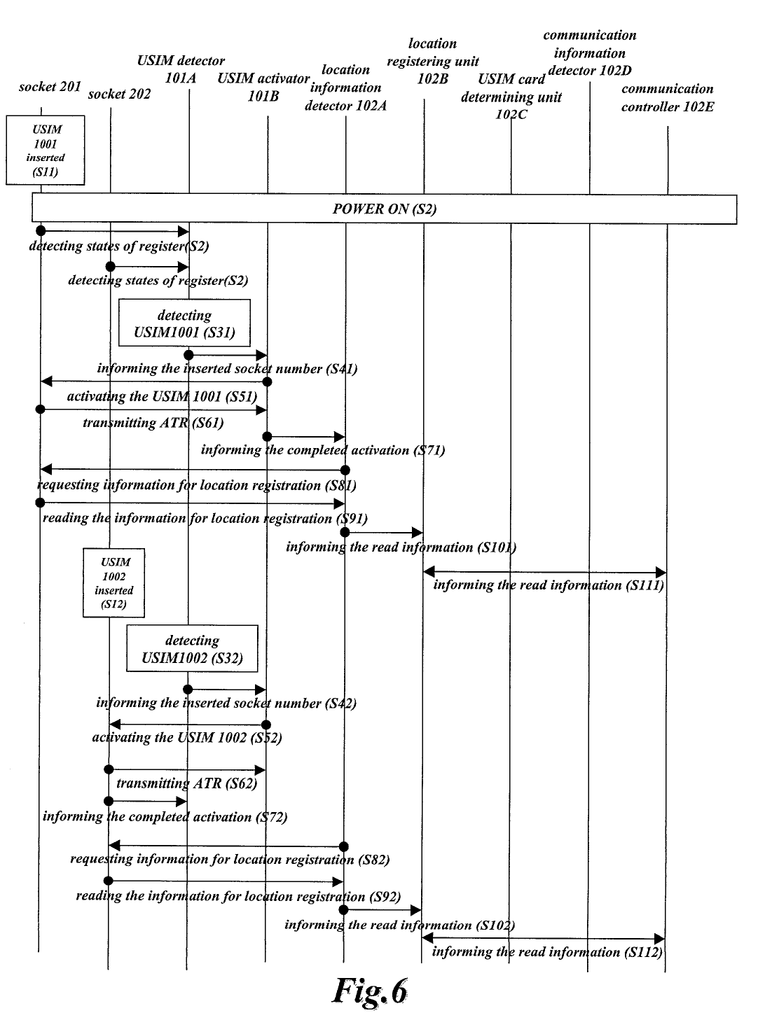

FIG. 6 shows a sequence when USIM card 1001 is inserted at power-up of communication apparatus 10, and subsequently a second USIM card 1002 is additionally inserted. In this sequence, USIM detector 101A detects the new insertion of USIM card 1002 with reference to a USIM card attachment-detachment status register, utilizing interruption processing.

When a power source in the communication apparatus is turned on by a user or automatically after USIM card 1001 is inserted into socket 201 (S11), detector 221 detects states of register in driver 241 (S2). USIM detector 101A detects that USIM card 1001 is inserted in socket 201 with reference to the detected register states (S31). USIM detector 101A informs USIM activator 101B of the inserted socket number (S41). USIM activator 101B activates USIM card 1001 inserted in socket 201 (S51). In this action, power and clock signals are supplied to USIM card 1001, for communicating with a mobile network with using USIM 1001. After being activated, USIM 1001 transmits ATR to USIM activator 101B (S61). USIM activator 101B can recognize that the activation of the USIM card 1001 has been completed upon receiving the ATR. The USIM activator 101B informs location information detector 102A that the activation of USIM card 1001 has been completed (S71).

After receiving notification that the activation of USIM card 1001 has been completed, location information detector 102A requests, for reading, information for location registration of card 1001 to a mobile network (S11), and reads the necessary information from USIM 1001 (S91). Location information detector 102A informs location registering unit 102B of the information read from USIM 1001 (S101). Location registering unit 102B informs the mobile network of the read information, for communicating using USIM card 1001 (S111).

When a power source in the communication apparatus is turned on by a user or automatically, after USIM card 1001 is inserted into socket 202 (S12), detector 222 detects states of register in driver 242 (S2). USIM detector 101A detects that USIM card 1002 is inserted in socket 202, with reference to the detected states (S32). The USIM detector informs USIM activator 101B of the inserted socket number (S42).

USIM activator 101B activates USIM card 1002 inserted in socket 202 (S52). In this action, power and clock signals are supplied to USIM card 1002, for communicating with a mobile network using USIM card 1002. After being activated, USIM card 1002 transmits ATR to USIM activator 101B (S62). The USIM activator 101B can recognize that the activation of the USIM card 1002 has been completed upon receiving the ATR. USIM activator 100B informs location information detector 102A that the activation of the USIM card 1002 has been completed (S72). After receiving notification that the activation of USIM card 1002 has been completed, location information detector 102A requests, for reading, information for location registration of card 1002 to a mobile network (S82), and reads the necessary information from USIM 1002 (S92).

Location information detector 102A informs location registering unit 102B of the information read from USIM 1002 (S102). Location registering unit 102B informs the mobile network of the read information, for communicating using USIM card 1002 (S112).

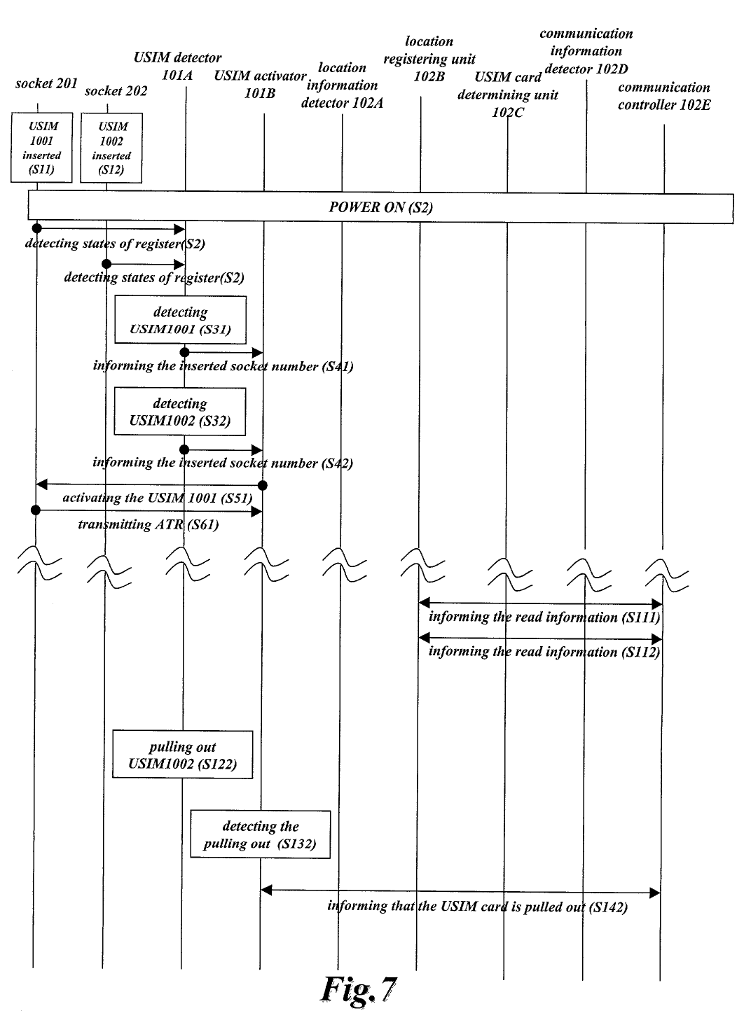

FIG. 7 shows an exemplary sequence carried out when USIM card 1002 is pulled out of socket 202 during a powered-up state. Process steps S11 to S112 in FIG. 7 are the same as the correspondingly numbered steps shown in FIG. 5.

When USIM card 1002 is pulled out of socket 202 (S122), USIM detector 101A detects the pulling-out of the USIM card 1002 with reference to the attachment-detachment status register of USIM card 1002, utilizing interruption processing (S132). USIM detector 101A informs communication controller 102E that USIM card 1002 is removed (S142). Communication controller 102E inhibits the communication using USIM card 1002.

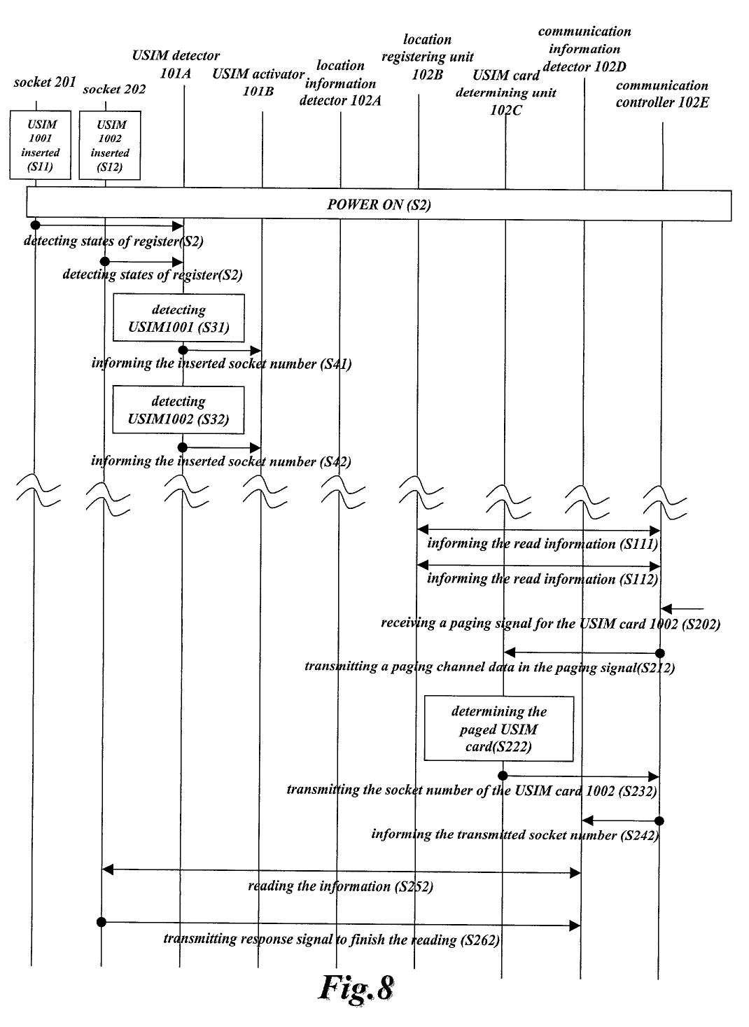

FIG. 8 shows an example of an incoming call initiating paging process carried out after a location registration using plural USIM cards is completed. The steps S11, S12, S2, S31, S41, S32, S42, S111 and S112 shown in FIG. 8 are the same as the correspondingly numbered steps shown in FIG. 4. In this embodiment, USIM card 1002 in the radio communication apparatus is paged.

The radio communication apparatus in this embodiment monitors a paging signal over a radio channel. A mobile network broadcasts the paging signal over the radio channel to initiate a communication link. By the monitoring, communication controller 102E in the radio communication apparatus determines whether or not a paging signal for paging the apparatus is received. When communication controller 102E determines that the received paging signal is for radio communication apparatus (S202), paging channel data included in the paging signal is transmitted to USIM card determining unit 102C for identifying a paged USIM card (S212). The mobile network has previously been informed, during the location registering process, of the radio communication apparatus information, including information about the USIM cards inserted into the apparatus.

USIM card determining unit 102C determines whether the received paging signal is paging USIM card 1001 or USIM card 1002, based on the paging channel data received from communication controller 102E (S222). In this example, the received paging signal is for paging USIM card 1002. After determining the paged card, USIM card determining unit 102C transmits the socket number of USIM card 1002 to communication controller 102E (S232). Communication controller 102E informs communication information detector 102D of the transmitted socket number, which indicates USIM card 1002 as the card from which information for communicating with the mobile network (S242) is to be read. Communication information detector 102D reads the information from USIM card 1002 (S252). After the reading processing, USIM card 1002 transmits to communication information detector 102D a response signal to finish the reading (S262).

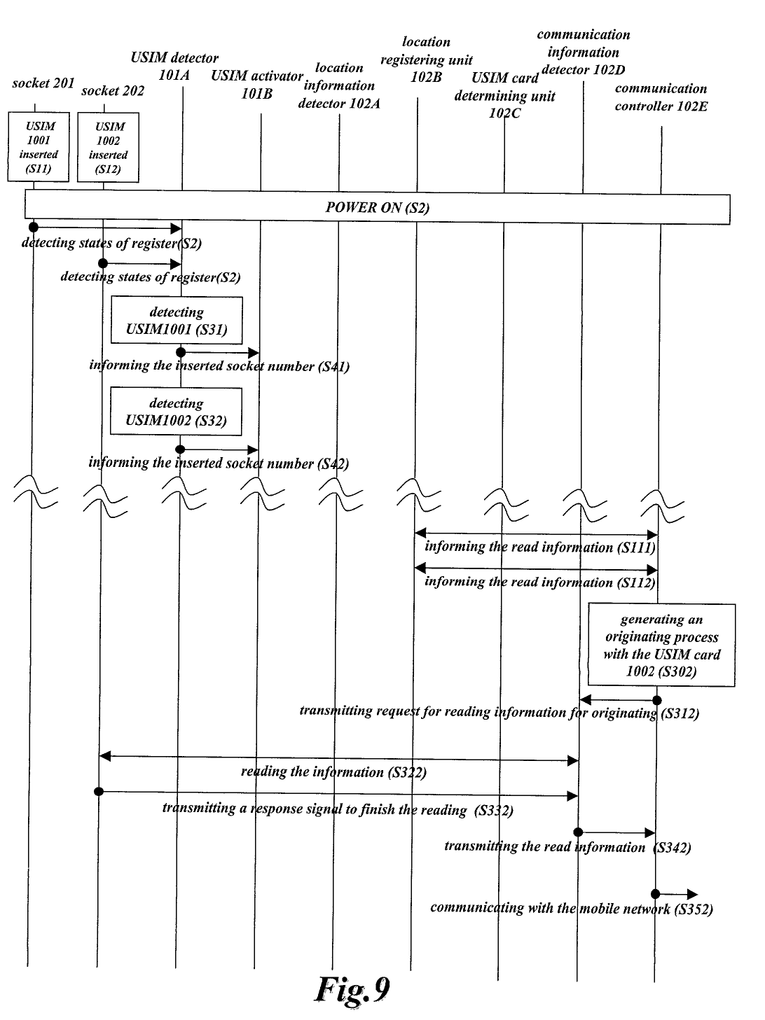

FIG. 9 shows an example of an originating process carried out after a location registration using plural USIM cards is completed. The steps S11, S12, S2, S31, S41, S32, S42, S111 and S112 shown in FIG. 9 are same as the correspondingly numbered steps shown in FIG. 4. In this embodiment, the USIM card for communicating with the mobile network can be selected by a key operation of a user.

When a user generates a call originating process with USIM card 1002 in the radio communication apparatus (S302), communication controller 102E transmits a request for reading information for communicating with the mobile network to communication information detector 102D (S312). Communication information detector 102D reads the information from USIM card 1002 (S322). After the reading processing, USIM card 1002 transmits to communication information detector 102D a response signal to finish the reading (S332). Communication information detector 102D transmits the read information to communication controller 102E (S342). Communication controller 102E communicates to the mobile network the transmitted information (S352).

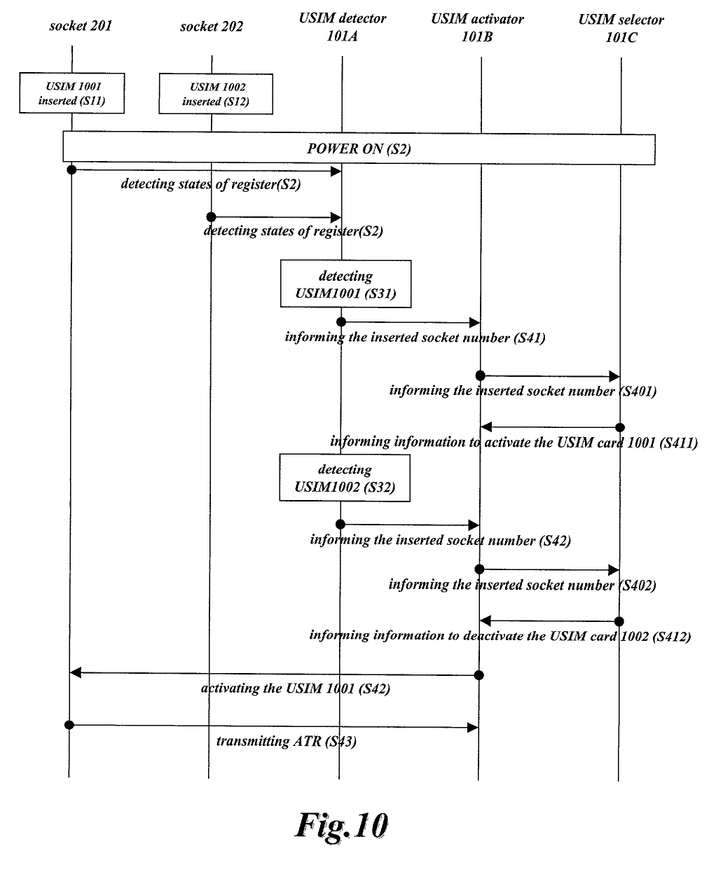

Each of FIGS. 10 to 13 shows a process carried out in the radio communication apparatus for automatically selecting a USIM card in the case that plural USIM cards are mounted in the apparatus.

FIG. 10 shows an exemplary process for switching an activated USIM card. In this embodiment, USIM selector 101C can select USIM card 1001 to activate according to a condition of the mobile apparatus. For example, when a power source in the communication apparatus is turned on by a user or automatically, after USIM card 1001 is inserted into socket 201 (S11) and USIM card 1002 is inserted into socket 202 (S12), detector 221 detects states of register in drivers 241 and 242 (S2). USIM detector 101A detects that USIM 1001 is inserted in socket 201 with reference to the detected states (S31). USIM detector 101A informs USIM activator 101B of the inserted socket number (S41). USIM activator 101B informs USIM selector 101C of the socket number (S401).

As described above, USIM selector 101C can select USIM card 1001 to activate according to a condition of the mobile apparatus. USIM selector 101C informs USIM activator 101B of information to activate USIM card 1001 (S411). For example, the condition in the mobile apparatus can be a time that USIM selector 101C detects. USIM selector 101C may select the USIM card to activate on the basis of the detected time. USIM selector 101C can select USIM card 1001 in the morning, and USIM card 1002 in the night, for example. Another condition can be a match of the MCC communicated by a mobile network and country code of the USIM card. If USIM card 1001, which has a country code “A”, and USIM card 1002, which has a country code “B”, are inserted in the radio communication apparatus, and the MCC communicated by the network is “A”, USIM selector 101C selects USIM card 1001 to activate in the radio communication apparatus. Another condition can be a cumulative time of calling to a particular country in the radio communication apparatus. For example, the apparatus has a USIM card 1001 whose country code is Japan, and a USIM card 1002 whose country code is Korea, and the user always, or usually, places calls to Japan from Korea, USIM selector 101C may select USIM card 1001 to activate in the radio communication apparatus, because the cumulative time to call to Japan is bigger than that to Korea. These conditions can be set by a user of the radio communication apparatus.

USIM detector 101A detects that USIM 1002 is inserted in socket 202 with reference to the detected states (S32). USIM detector 101A informs USIM activator 101B of the inserted socket number (S42). USIM activator 101B informs USIM selector 101C of the socket number (S402). As described above, USIM selector 101C selects USIM card 1001 to activate in advance, in this embodiment. USIM selector 101C informs USIM activator 101B of information to deactivate USIM card 1002 (S412). USIM activator 101B activates USIM 1001 inserted in socket 201 (S42). In this action, power and clock signals are supplied to USIM 1001 for communicating with a mobile network using USIM 1001. After being activated, USIM card 1001 transmits ATR to USIM activator 101B (S43). USIM activator 101B can recognize that activation of USIM card 1001 has been completed upon receiving the ATR.

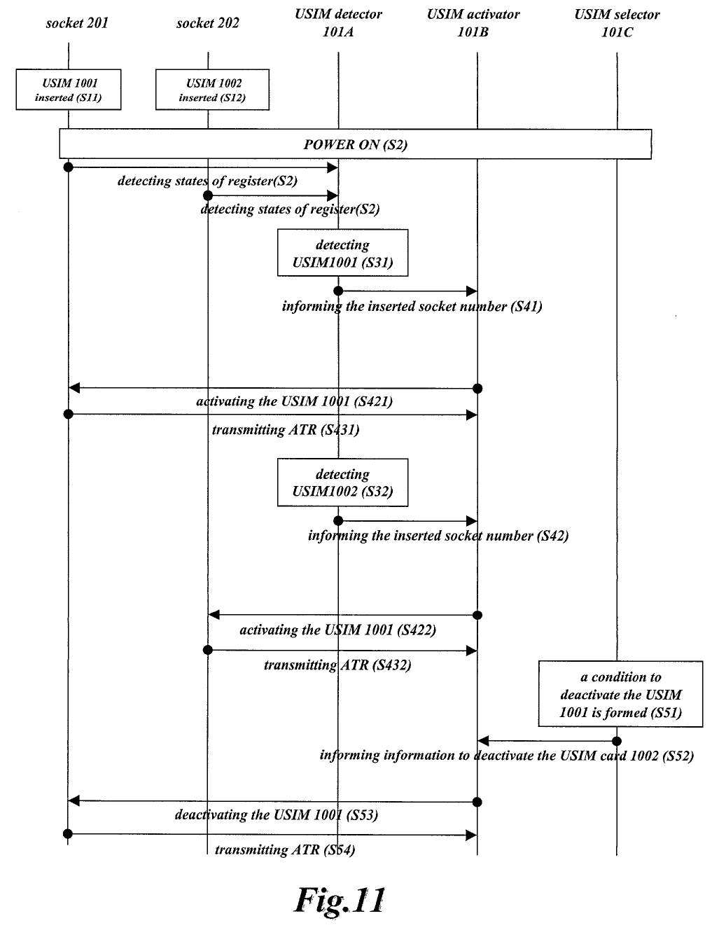

FIG. 11 shows an exemplary process for changing an activated USIM card to a deactivated one. In this embodiment, USIM selector 101C can select USIM card 1001 to deactivate according to the above-described condition of the mobile apparatus. When a power source in the communication apparatus is turned on by a user or automatically, after USIM card 1001 is inserted into the socket 201 (S11) and USIM card 1002 is inserted into socket 202 (S12), detector 221 detects states of register in driver 241 and driver 242 (S2). USIM detector 101A detects that USIM 1001 is inserted in socket 201 with reference to the detected states (S31). USIM detector 101A informs USIM activator 110 B of the inserted socket number (S41).

USIM activator 101B activates USIM 1001 inserted in socket 201 (S421). In this action, power and clock signals are supplied to USIM card 1001, for communicating with a mobile network using USIM card 1001. After being activated, USIM 1001 transmits ATR to USIM activator 101B (S431). USIM activator 101B can recognize that the activation of the USIM card 1001 has been completed upon receiving the ATR.

USIM detector 101A detects that USIM 1002 is inserted in socket 202 with reference to the detected states (S32). USIM detector 101A informs USIM activator 101B of the occupied socket number (S42). USIM activator 101B activates USIM 1002 inserted in socket 202 (S422). In this action, power and clock signals are supplied to USIM 1002 for communicating with a mobile network using USIM card 1002. After being activated, USIM 1002 transmits ATR to USIM activator 101B (S432). USIM activator 101B can recognize that the activation of the USIM card 1002 has been completed by receiving the ATR.

When an above-described condition to deactivate the USIM card 1001 is formed (S51), USIM selector 101C communicates to USIM activator 101B information to deactivate USIM card 1001 (S52). USIM activator 101B deactivates USIM 1001 inserted in socket 201 (S53). After being deactivated, USIM 1001 transmits ATR to USIM activator 101B (S54).

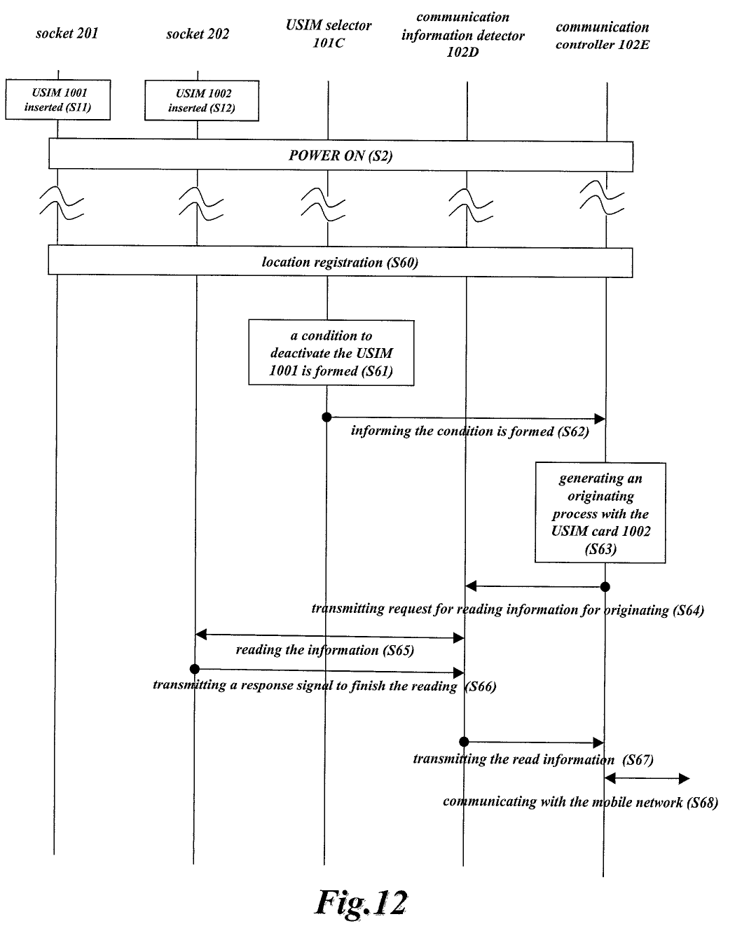

FIG. 12 shows a process for switching a USIM card with which to communicate. USIM card 1001 and USIM card 1002 are set to complete the registration of location information with a network (S60). The process used may be the same as that described in FIG. 4, up to and through the location information registering process.

When an above-described condition to deactivate the USIM card 1001 is formed (S61), USIM selector 101C communicates to communication controller 101E information to deactivate USIM card 1001 (S62). When a user generates a call originating process with USIM card 1002 in the radio communication apparatus (S63), communication controller 102E transmits a request, for reading information for communicating with the mobile network, to communication information detector 102D (S64). Communication information detector 102D reads the information from USIM card 1002 (S65). After the reading processing, USIM card 1002 transmits a response signal to finish the reading, to communication information detector 102D (S66). The communication information detector 102D transmits the read information to communication controller 102E (S67). Communication controller 102E communicates to the mobile network the transmitted information (S68). When an originating process with USIM card 1001 is generated in this state, notification of invalidation of the origination process using USIM card 1001 is provided to a user by e.g., displaying this notification in a display of the radio communication apparatus.

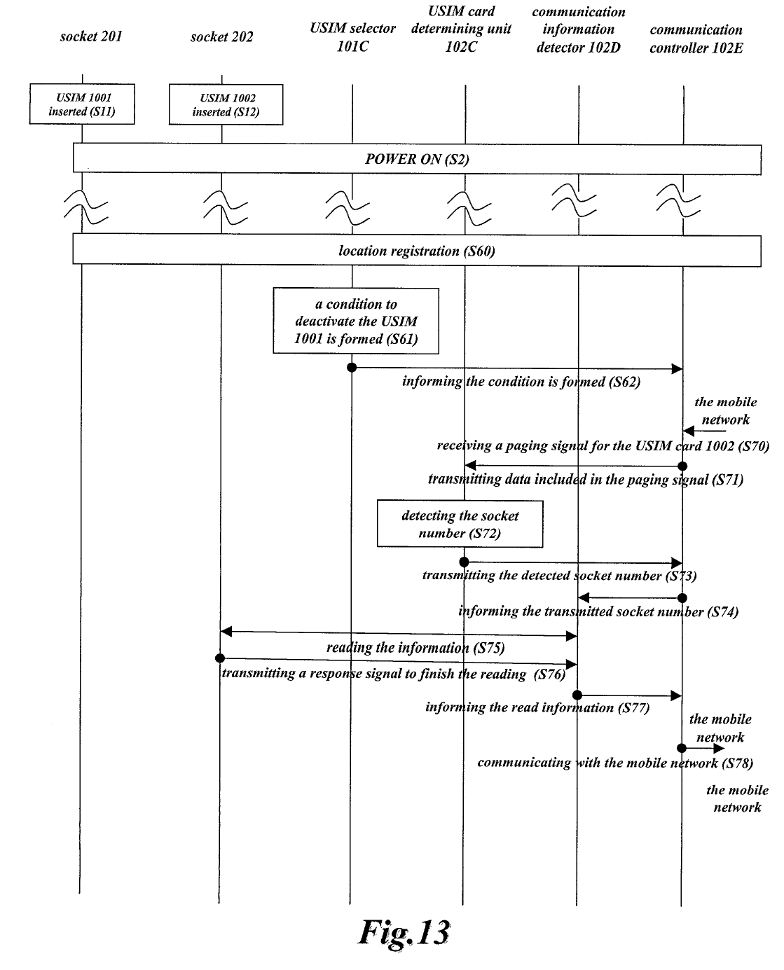

FIG. 13 shows another process for switching a USIM card with which to communicate. Both USIM card 1001 and USIM card 1002 are set to complete the registration of location information with a network (S60). The process used may be the same as that described in FIG. 4, up to and through the location information registering process.

When an above-described condition to deactivate the USIM card 1001 is formed (S61), USIM selector 101C communicates to communication controller 101E information to deactivate USIM card 1001 (S62). After this process, communication controller 102E cannot communicate with a mobile network using USIM card 1001.

Communication controller 102E monitors a paging signal received from a mobile network and determines whether the monitored paging signal is for paging USIM card 1001 or USIM card 1002 (S70). The paging signal is for paging USIM card 1002 in this example.

After communication controller 102E detects that the paging signal is for paging USIM card 1002, paging channel data included in the paging signal is transmitted to USIM card determining unit 102C to identify a socket number (S71). USIM card determining unit 102C detects the socket number of USIM card 1002 from the transmitted data (S72). USIM card determining unit 102C transmits the detected socket number of USIM card 1002 to communication controller 102E (S73). Communication controller 102E informs communication information detector 102D of the transmitted socket number, to read information for communicating with the mobile network (S74). Communication information detector 102D reads the information from USIM card 1002 (S75). After the reading processing, USIM card 1002 transmits a response signal to finish the reading to the communication information detector 102D (S76). Communication information detector 102D informs communication controller 102E of the read information (S77). After the read information is received, communication controller 102E communicates with the mobile network (S78).

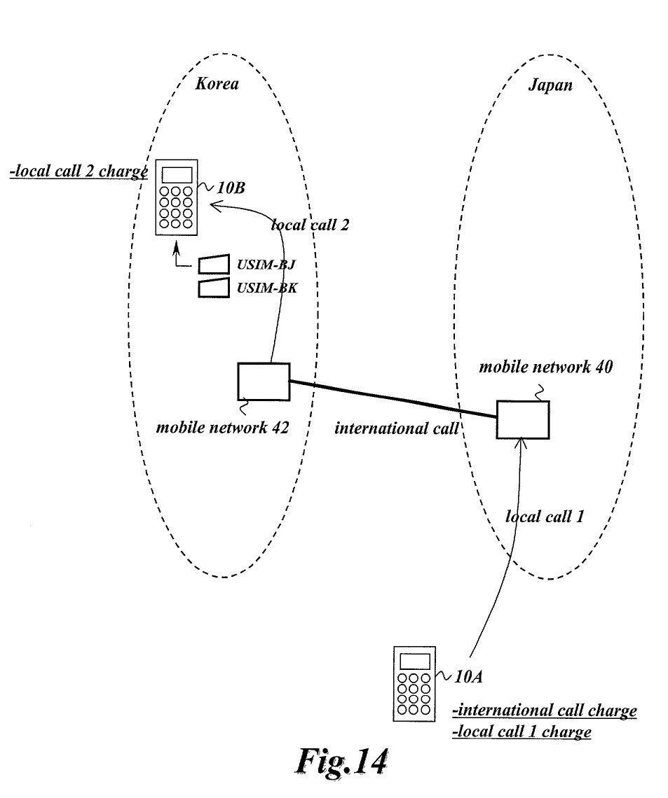

FIG. 14 shows an exemplary application of automatic selection from among plural USIM cards mounted in a radio communication apparatus, to communicate with a mobile network. In this example, a radio communication apparatus 10B can communicate with a mobile network using a USIM card BJ or a USIM card BK. The USIM cards are inserted into apparatus 10B. USIM card BJ has a country code indicating Japan. USIM card BK has a country code indicating Korea. Apparatus 10B is set in advance to communicate with the mobile network using only an inserted USIM card, having a country code which is the same as the MCC broadcasted by the mobile network. If apparatus 10B is located in Korea, apparatus 10B selects USIM card BK to communicate with a mobile network 42 and communicates with the mobile network 42 in Korea using only USIM card BK.

In a mobile communication network system of the prior art, a radio apparatus accommodates only one USIM card. If the USIM card has a country code which indicates Japan, the home location of Japan is registered in the mobile network 40. When the user of a radio communication apparatus 10A originates a call to a radio communication apparatus in Korea, a local call 1 (shown in FIG. 14) charge is charged to the user of apparatus 10A. The international call charge (shown in FIG. 14) and local charge 2 (shown in FIG. 14) are paid by the user of the apparatus in Korea.

On the other hand, in accordance with the invention, apparatus 10B has selected card BK which is registered in mobile network 42. When the user of radio communication apparatus 10A originates a call to radio communication apparatus 10B, a local call 1 charge and an international call charge are charged to the user of apparatus 10A. Local charge 2 is paid by the user of the apparatus 10B. This process helps the user of the apparatus 10B decrease a call charge.

As mentioned above, plural mounted USIM cards can be selectively used by recognizing the USIM cards in a mobile communication apparatus, and selectively individually accessing each of the USIM cards. Further, a mobile communication apparatus can communicate with selected ones of the plural USIM cards, to reduce the call charges to the mobile communication apparatus.

While the invention has been described with respect to specific examples including presently preferred modes of carrying out the invention, those skilled in the art will appreciate that there are numerous other embodiments, and variations and permutations of the above described exemplary embodiments, that fall within the scope and spirit of the invention as set forth in the appended claims.

1. A mobile communication apparatus for communicating with a network selectively utilizing a plurality of IC units connected to the apparatus, each of the IC units having data for establishing a communication link with the network, the apparatus comprising:
a detector configured to detect each of the IC units connected to the apparatus;
an activator configured to activate at least one of the detected IC units for communication with the network; and
a controller configured to inform the network of data in the activated IC unit(s).

2. The mobile communication apparatus according to claim 1, wherein the activator is configured to activate more than one of the detected IC units for communication with the network.

3. The mobile communication apparatus according to claim 1, wherein the apparatus is configured to initiate establishment of a communication link with the network.

4. The mobile communication apparatus according to the claim 1, the apparatus further comprising a selector configured to select an activated IC unit for use in establishing a communication link with the network.

5. The mobile communication apparatus according to the claim 4, wherein the activator is further configured to deactivate a non-selected IC unit.

6. The mobile communication apparatus according to claim 4, wherein the selector selects an activated IC unit for use in establishing a communication link with the network based upon a time at which the mobile communication apparatus is used.

7. The mobile communication apparatus according to claim 4, wherein the selector selects an activated IC unit for use in establishing a communication link with the network based upon data broadcasted from the network.

8. The mobile communication apparatus according to claim 7, wherein the data indicates a location of the mobile communication apparatus.

9. The mobile communication apparatus according to claim 8, wherein the data indicates a country where the mobile communication apparatus is located.

10. The mobile communication apparatus according to claim 7, wherein each IC unit has a country code indicating a home location of the mobile communication apparatus, and the selector selects for use in establishing a communication link with the network an activated IC unit that has a broadcasted home location code.

11. A method for selectively utilizing a plurality of IC units connected to a mobile communication apparatus for communicating with a network, each of the IC units having data for establishing a communication link with the network, the method comprising:
detecting each of the IC units connected to the apparatus;
activating at least one of the detected IC units for communication with the network; and
informing the network of data in the activated IC unit(s).

12. The method according to claim 11, wherein more than one of the detected IC units are activated for communication with the network.

13. The method according to claim 11, said method further comprising initiating from said apparatus a communication link with the network.

14. The method according to the claim 1, further comprising selecting an activated IC unit for use in establishing a communication link with the network.

15. The method according to the claim 14, further comprising deactivating a nonselected IC unit.

16. The method according to claim 14, wherein said selecting of an activated IC unit is carried out based upon a time at which the mobile communication apparatus is used.

17. The method according to claim 14, wherein said selecting of an activated IC unit is carried out based upon data broadcasted from the network.

18. The method according to claim 17, wherein the data indicates a location of the mobile communication apparatus.

19. The method according to claim 18, wherein the data indicates a country where the mobile communication apparatus is located.

20. The method according to claim 17, wherein each IC unit has a country code indicating a home location of the mobile communication apparatus, and wherein an activated IC unit that has a broadcasted location code is selected for use in establishing a communication link with the network.

21. A mobile communication apparatus for receiving a plurality of IC units to communicate with a network, each of the IC units having data for establishing a communication link with the network, the apparatus comprising:
a plurality of sockets configured to receive said plurality of IC units;
a detector configured to detect an IC unit received in a said socket;
an activator configured to activate the detected IC unit for communication with the network; and
a controller configured to inform the network of data in the activated IC unit.

22. The mobile communication apparatus according to claim 21, wherein said activator is configured to activate a second IC unit inserted into one of said sockets after a first unit has been inserted into another socket.

23. The mobile communication apparatus according to the claim 21, the apparatus further comprising a selector configured to select an activated IC unit to communicate with the network.

24. The mobile communication apparatus according to the claim 23, wherein the activator is further configured to deactivate a non-selected IC unit.

25. The mobile communication apparatus according to claim 23, wherein the selector selects an activated IC unit for use in establishing a communication link with the network based upon a time at which the mobile communication apparatus is used.

26. The mobile communication apparatus according to claim 23, wherein the selector selects an activated IC unit for use in establishing a communication link with the network based upon data broadcasted from the network.

27. The mobile communication apparatus according to claim 26, wherein the data indicates a location of the mobile communication apparatus.

28. The mobile communication apparatus according to claim 27, wherein the data indicates a country where the mobile communication apparatus is located.

29. The mobile communication apparatus according to claim 26, wherein each IC unit has a country code indicating a home location of the mobile communication apparatus, and the selector selects, for use in establishing a communication link with the network, an activated IC unit that has a broadcasted home location code.

30. A method carried out in a mobile communication apparatus for communicating with a network, said apparatus having a plurality of sockets for receiving a plurality of IC units, each of the IC units having data for establishing a communication link with the network, the method comprising:
detecting an IC unit received in a said socket;
activating the detected IC unit for communication with the network; and
informing the network of data in the activated IC unit.

31. The method according to claim 30, further comprising activating a second IC unit inserted into one of said sockets, after a first unit has been inserted into the other socket.

32. The method according to the claim 30, further comprising selecting an activated IC unit for use in establishing a communication link with the network.

33. The method according to the claim 32, further comprising deactivating a non-selected IC unit.

34. The method according to claim 30, wherein said selecting of an activated IC unit is carried out based upon a time at which the mobile communication apparatus is used.

35. The method according to claim 30, wherein said selecting of an activated IC unit is carried out based upon data broadcasted from the network.

36. The method according to claim 35, wherein the data indicates a location of the mobile communication apparatus.

37. The method according to claim 36, wherein the data indicates a country where the mobile communication apparatus is located.

39. The method according to claim 35, wherein each IC unit has a country code indicating a home location of the mobile communication apparatus, and wherein an IC unit that has a broadcasted location code is selected for use in establishing a communication link with the network.
